(19) United States
(12) Patent Application Publication
(10) Pub. No.: US 2025/0045771 A1
(43) Pub. Date: Feb. 6, 2025

(54) EMISSION FOOTPRINT CALCULATION AND CONSUMPTION

(71) Applicant: SAP SE, Walldorf (DE)

(72) Inventor: Ranjit Alapati, Bangalore (IN)

(21) Appl. No.: 18/364,406

(22) Filed: Aug. 2, 2023

(51) Int. Cl. G06Q 30/018

(52) U.S. Cl. CPC G06Q 30/018

(57) ABSTRACT

Emission footprints can be calculated and provided for consumption by software applications. To do this, product data including a quantity of a product, components of the product, and activities for the product are obtained. Emission factor data for the components indicating a carbon dioxide impact of the components per unit are obtained. One or more emissions footprints are calculated per product, per material, and per activity based on a time period, the quantity, the components, the activities, and the emission factor data. Each of the emissions footprints indicates an amount of carbon dioxide per unit for a corresponding product, material, or activity. The calculated emissions footprints for the time period are provided via an application programming interface or as a published event.

### BACKGROUND

The present disclosure pertains to emission footprints and in particular to calculation and consumption of emission footprints. Emission footprints can provide insights regarding the environmental impact of products. The environmental impact includes greenhouse gas emissions, which may be measured using CO₂ or CO₂ equivalent (CO₂e) in kilograms, for example.

Emission footprints can be used for disclosures or for internal product and process optimization. However, emission footprints are not integrated across certain software applications or computer systems. There is a need for improved integration of emission footprints such that they can be consumed by software applications.

The present disclosure addresses these issue and others, as further described below.

### SUMMARY

One embodiment provides a computer system. The computer system comprises one or more processors and one or more machine-readable medium coupled to the one or more processors. The machine-readable medium store computer program code that comprises sets of instructions. The sets of instructions are executable by the one or more processors to obtain product data including a quantity of a product, components of the product, and activities for the product. The sets of instructions are executable by the one or more processors to obtain emission factor data for the components indicating a carbon dioxide impact of the components per unit. The sets of instructions are executable by the one or more processors to calculate one or more emissions footprints per product, per material, and per activity based on a time period, the quantity, the components, the activities, and the emission factor data. Each of the emissions footprints indicates an amount of carbon dioxide per unit for a corresponding product, material, or activity. The sets of instructions are executable by the one or more processors to provide the one or more calculated emissions footprints for the time period via an application programming interface or as a published event.

Another embodiment provides a non-transitory computer-readable medium storing computer program code. The computer program code comprises sets of instructions to obtain product data including a quantity of a product, components of the product, and activities for the product. The computer program code comprises sets of instructions to obtain emission factor data for the components that indicates a carbon dioxide impact of the components per unit. The computer program code comprises sets of instructions to calculate one or more emissions footprints per product, per material, and per activity based on a time period, the quantity, the components, the activities, and the emission factor data. Each of the emissions footprints indicates an amount of carbon dioxide per unit for a corresponding product, material, or activity. The computer program code comprises sets of instructions to provide the one or more calculated emissions footprints for the time period via an application programming interface or as a published event.

Another embodiment provides a computer-implemented method. The method comprises obtaining product data including a quantity of a product, components of the product, and activities for the product. The method comprises obtaining emission factor data for the components that indicate a carbon dioxide impact of the components per unit. The method also comprises calculating one or more emissions footprints per product, per material, and per activity based on a time period, the quantity, the components, the activities, and the emission factor data. Each of the emissions footprints indicates an amount of carbon dioxide per unit for a corresponding product, material, or activity. The method also comprises providing the one or more calculated emissions footprints for the time period via an application programming interface or as a published event.

The following detailed description and accompanying drawings provide a better understanding of the nature and advantages of the present disclosure.

### BRIEF DESCRIPTION OF THE DRAWINGS

FIG. 1 shows a diagram of a footprint management computer system providing emission footprints via an application programming interface and/or published events, according to an embodiment.

FIG. 2 shows a flowchart of a computer-implemented method for providing emission footprints via an application programming interface (API) and/or published events, according to an embodiment.

FIG. 3 shows a diagram of API based integration providing emission footprints for consumption, according to an embodiment.

FIG. 4 shows a diagram of data event based integration providing emission footprints for consumption, according to an embodiment.

FIG. 5 shows a diagram of activity event and API based integration providing emission footprints for consumption, according to an embodiment.

FIG. 6 shows a diagram of a persistency data model for emission footprints, according to an embodiment.

FIG. 7 shows an illustration of consumption of an emission footprint and shows emissions per product component, according to an embodiment.

FIG. 8 shows an illustration of consumption of an emission footprint and shows emissions per product and vendor, according to an embodiment.

FIG. 9 shows an illustration of consumption of an emission footprint and shows emissions per shipping options from a vendor, according to an embodiment.

FIG. 10 shows a diagram of hardware of a special purpose computing machine for implementing systems and methods described herein.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident, based on the language of the different claims, that the claimed subject matter may include some or all of the features in these examples, alone or in combination, and may further include modifications and equivalents of the features and techniques described herein.

In the figures and their corresponding description, while certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner. In addition, hardwired circuitry may be used independently or in combination with software instructions to implement the techniques described in this disclosure. The described functionality may be performed by custom hardware components containing hardwired logic for performing operations, or by any combination of computer hardware and programmed computer components. The embodiments described in this disclosure are not limited to any specific combination of hardware circuitry or software. The embodiments can also be practiced in distributed computing environments where operations are performed by remote data processing devices or systems that are linked through one or more wired or wireless networks. As used herein, the terms “first,” “second,” “third,” “fourth,” etc., do not necessarily indicate an ordering or sequence unless indicated. These terms, as used herein, may simply be used for differentiation between different objects or elements.

As mentioned above, emission footprints can provide insights regarding the environmental impact of products. The environmental impact includes greenhouse gas emissions, which may be measured using CO₂ or CO₂ equivalent (CO₂e) in kilograms, for example. Emission footprints can be used for disclosures or for internal product and process optimization. However, emission footprints are not integrated across certain software applications or computer systems.

The present disclosure provides techniques for improved integration of emission footprints such that they can be consumed by software applications. A footprint manager software application or computer system can be configured to calculate emission footprints and provide them to other software applications or computer systems such that the footprints can be consumed for the in or by the receiving software application or computer system. The footprints can be consumed in a loosely integrated manner using events or event-based notifications. The footprints can also be pulled or consumed on an on-demand basis. For instance, the receiver may decide when to pull the footprints. The footprints may also be provided along with additional information such that they can be analyzed based on attributes like periods, geographies, product categories, and so on.

As further described below, a footprint management application or computer system may acquire master data and transaction data, such as products, production orders, and goods movement documents from an internal or external source system. This data is then used as basis along with emission factors data, which may come from Life Cycle Assessment Data Providers or Supplier emission factors (also known as “primary data”) through various calculators to calculate footprints for a product. The calculations take into account emission due to own manufacturing process, material acquisition from suppliers along with emissions due to transportation. These footprints and environmental impact data can be used within the footprint manager to make sustainable decisions in business that can be related to procurement of components (e.g., materials) from supplier with lower footprints or improve production processes to reduce the emissions or use transportation modes and routes with less emissions, for example.

There are many scenarios where the footprints calculated in a footprint management solution are relevant for consumption by various software applications and computer systems. Examples of footprint consumption include: strategic buying of purchased components with less environmental impact; providing environmental impact when goods are sold to the customer, display the environmental impact data along with the catalog of products; providing guided buying scenarios where the environmental impact data can help consumers to procure products with lesser footprints; providing footprints that can be filtered and sorted in an analytics application based on various dimensions like product categories, geo-locations, suppliers, transport modes, alternate fuels to act and optimize their production process, freight transportation to reduce the footprints; and using the footprints either for sustainable buying, selling or reporting of the footprints.

Different software applications and computer systems may require specific consumption methods for using and integrating footprints. For example, a cloud based system may use an internal API based approach and an event based approach so that the various cloud applications like procurement and sales have the choice to choose whether loose coupling via events or tight coupling via API. As another example, an application may require the footprints to be available in a standard format so that all suppliers can use them to provide footprint in consistent and unified format for their consumers. As another example, external applications (e.g., outside of the computer system providing the footprint management application), may require or prefer to have a loosely coupled integration with the event-based approach. As another example, for analytics, along with footprints it is useful to provide more dimensions like product category, periods, geo-locations, transport modes, fuel/energy types and so on to do analysis of environmental data using slice and dicing over different dimensions. The techniques for footprint calculation and consumption described below address these different needs.

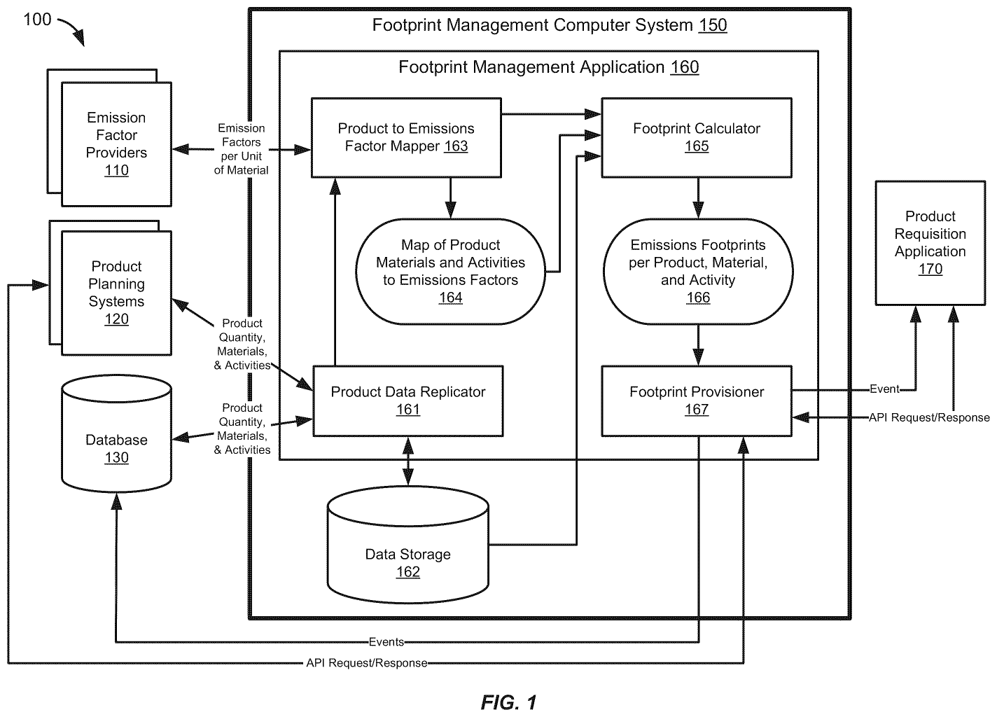

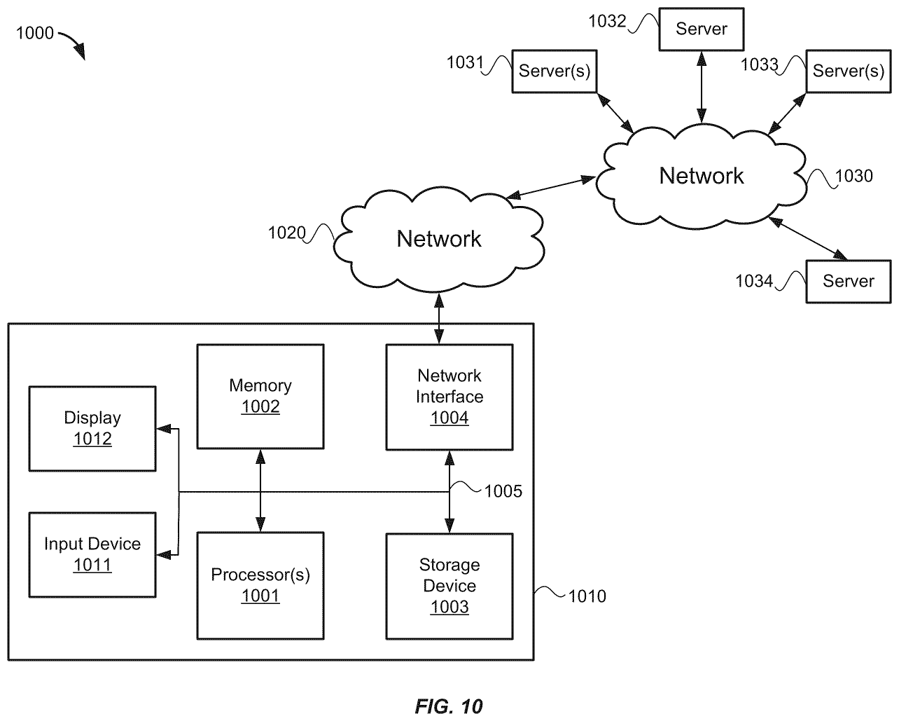

FIG. 1 shows a diagram 100 of a footprint management computer system 150 providing emission footprints via an application programming interface and/or published events, according to an embodiment. The footprint management computer system 150 may be implemented in a cloud computing platform or by an on-premise computer system, for example. The footprint management computer system 150 may include one or more server computers, for example. The computer system 150 may include computer hardware as described below with respect to FIG. 10.

The footprint management computer system 150 operates a footprint management software application 160, which provides the emission footprints. In short, the footprint management application 160 is configured to calculate emission footprints using emission factor data and product data and then provide the emission footprints via an application programming interface and/or as published events. The emission footprints may then be consumed whereby the calculated emission footprint information is stored in a database with the source product data, integrated in a product planning software application, or integrated in a purchase requisition software application, for example.

To provide the emission footprints, the footprint management application 160 includes software components including a product data replicator 161 component, a product to emissions factor mapper 163 component, a footprint calculator 165 component, and a footprint provisioner 167 component, which are described below.

The footprint management application 160 obtains and stores product data for one or more products using the product data replicator 161 software component. The product data replicator 161 component is configured to obtain product data including a quantity of a product, components of the product, and activities for the product. For instance, the product data may indicate a product quantity and unit of measure, a set of components used to produce the product and the quantity of those components, and activities for the product (e.g., activities performed in producing the product, activities in transporting the product, activities for producing underlying components or components for the product, etc.). As an example, a laptop computer is a product comprising a hard disk, random access memory, a battery, a processor, and other components. Product data for the laptop computer product may indicate a number of laptops produced (e.g., within a specified time period), components used to produce the laptop (e.g., hard disk, random access memory, etc.), components of those components (e.g., circuit board material, wiring material, etc.), and activities for producing the laptop (e.g., manufacturing of components including machinery used, shipping transportation of the components, assembly and associated assembly line machinery, shipping to a distributor, etc.).

The product data replicator 161 obtains product data from one or more product planning systems 120 or from a database such as database 130. The product planning systems 120 may provide resource planning applications which provide such product data via an application programming interface, for example. In some embodiments, the product planning systems 120 may be implemented as part of a cloud computing platform or in an on-premise system, for example. In some embodiments the product planning systems 120 and the database 130 may be part of a same computer system as the footprint management computer system 150.

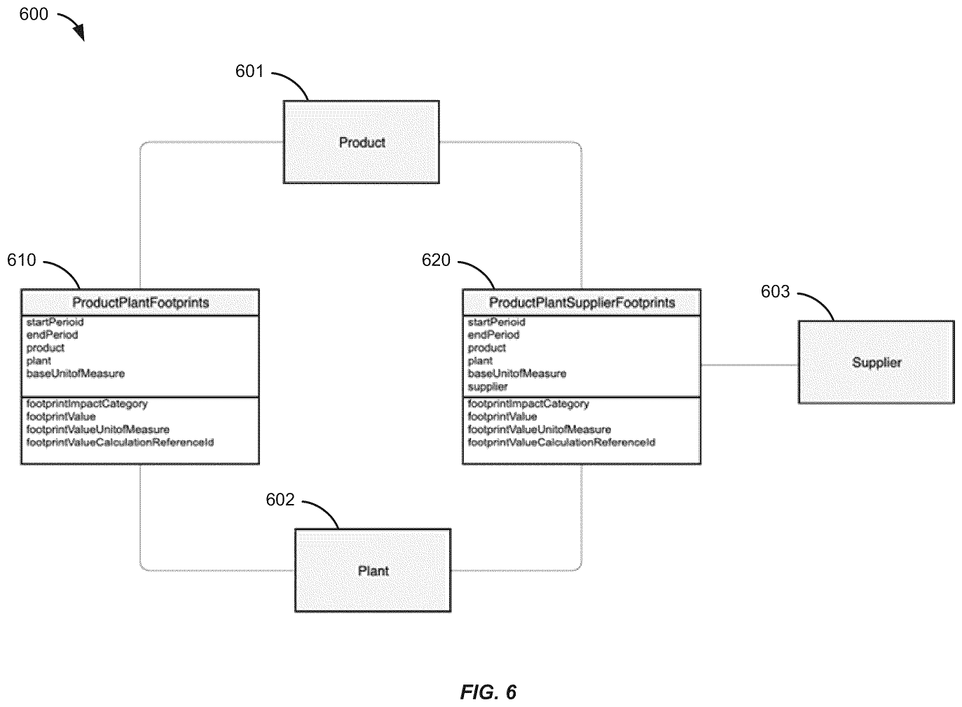

The obtained product data is replicated and stored in data storage 162 of the footprint management computer system. The data storage 162 may be part of a database. Emission factor data and calculated emission footprints, which are described below, may also be stored in product data storage. The emissions footprints may be stored according to a persistency model as described below with respect to FIG. 6.

Calculation of the emissions footprints uses the product data along with emission factor data for the products. The product data is mapped to the emission factor data by a product to emissions factor mapper 163 software component. The mapper 163 component generates a map 164 of product components and activities to emissions factors. The map 164 may indicate which components, components, and activities for the product correspond to which emissions factors (e.g., the amount of carbon emitted when collecting, producing, transporting or performing a particular unit or quantity of the corresponding material, component, or activity).

The emission factor data may include one or more of an impact category (e.g., greenhouse gases), a footprint indicator (e.g., global warming potential), and a respective emission factor value for one or more products, components of products, components, or activities (e.g., CO₂ or CO₂ equivalent in kilograms per kilogram of product, kilogram of material, or per activity etc.). The emissions factor value for a material or activity indicates the carbon dioxide impact of that material or activity on the Earth's environment. In some embodiments this emission factor data may be obtained from a supplier or from a life cycle assessment data provider, as mentioned above.

The mapper 163 is configured to obtain emission factor data for the components indicating a carbon dioxide impact of the components per unit. The mapper 163 obtains the emissions factors from emission factor providers 110. In some embodiments this emission factor data may be obtained from a supplier or from a life cycle assessment data provider. For example, emission factor data for components may be obtained from the supplier of that material. As another example, emission factor data estimates for products or components (e.g., estimates per region or per country) may be obtained from a life cycle assessment data provider. In some embodiments, emission factor data for activities may be obtained from the resource planning system which provided the master data and the transaction data. In some embodiments, emission data may be obtained from a Lifecycle Analysis (LCA) provider. As an example, emission factor data for an oven product running in the European Union region for 30 minutes may produce 1.358 Kg of Co2e.

A footprint calculator component 165 is configured to calculate emissions footprints 166 per product, per material, and per activity based on a time period, the quantity, the components, the activities, and the emissions factor data. Each of the emissions footprints 166 may indicate an amount of carbon dioxide per unit for the corresponding product, material, or activity. In some embodiments the amount of carbon dioxide per unit may be CO₂ in kilograms or it may be CO₂ equivalent in kilograms (e.g., methane gases converted to their CO₂ equivalent). The time period may be used to restrict the calculation to components used and activities performed to make products during that time period. The time period may be set according to predefined time intervals (e.g., monthly, quarterly) or it may be selected by a computer user (e.g., a user of the footprint management application 160). In some embodiments, the emissions footprint calculation may be a bottom up calculation where the corresponding carbon emissions of all components and activities (e.g., manufacturing equipment use, transportation, etc.) used in producing the product are included.

A footprint provisioner component 167 may be configured to provide one or more calculated emissions footprints for the time period via an application programming interface or as a published event. The emissions footprint may be a carbon footprint or greenhouse gas footprint and may quantify the amounts of emissions that were directly or indirectly part of producing the product. The emission footprint may indicate carbon dioxide amounts or carbon dioxide equivalent emitted in producing a certain quantity of product.

In some embodiments the emission footprints may be pushed by the footprint provisioner 167 to another computer system using an API provided by that other computer system. In some embodiments the emission footprints may be pulled from the footprint provisioner 167 by other computer systems. In embodiments where the emission footprints are provided as published events, the footprint provisioner 167 may provide the emission footprints to an event broker or event mesh enabling computer system to subscribe to events.

For example, the footprint provisioner 167 may publish events including the calculated emissions footprints to the database 130 such that the calculated emissions footprints may be stored along with the source product data. The emission footprints may be stored in columns of the database and may be viewed in a table along with columns of product data, for example.

As another example, the footprint provisioner 167 may provide an API that can be accessed by the product planning systems 120 to pull the calculated emissions footprints such that they may be consumed along with the source product data. For instance, the calculated emissions footprints may be included in a sale order application providing a user interface for ordering the product from a manufacturer or it may be used in an online shopping cart application to show carbon dioxide emissions from the procurement of raw components and freight transportation to enable the users to make decisions based on environmental sustainability as well as cost and delivery. Thus, material purchase decisions in product planning can consider the differences in emissions factors and their resulting emission footprint.

As another example, the footprint provisioner 167 may provide notifications to a product requisition application 170 when emission footprints are calculated using events and also provide an application programming interface that is usable by the product requisition application 170 to pull the emissions footprints. For instance, the emissions footprints may be integrated into a purchase requisition application such that the user can see the CO₂ equivalent environmental impact along with the financial value.

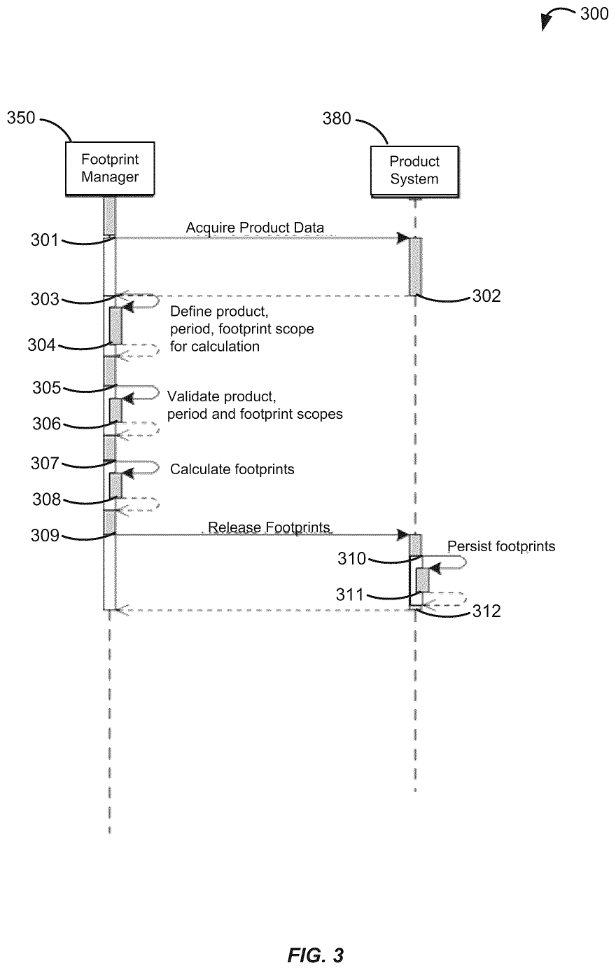

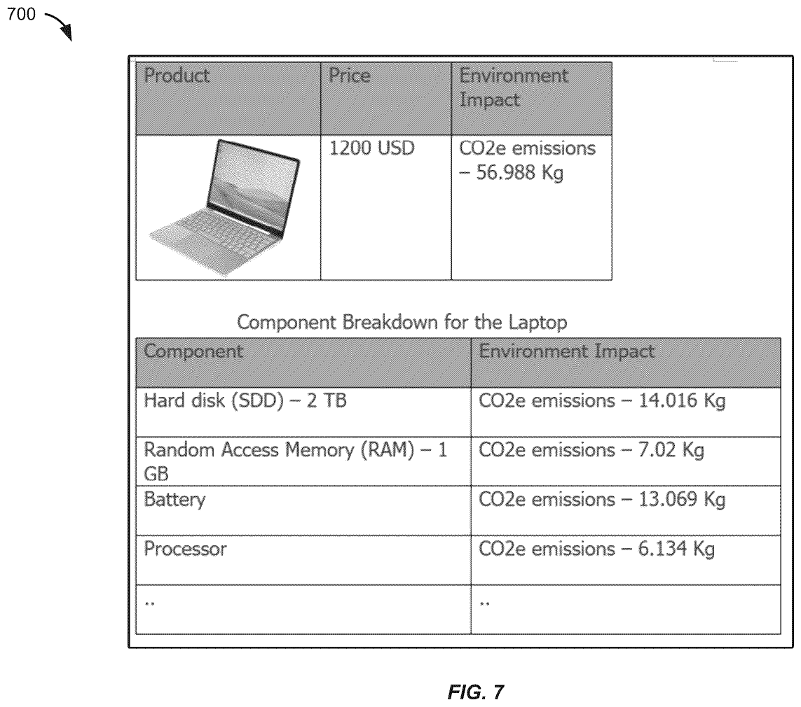

Further details of the API and event based integration are provided with respect to FIG. 3-5. A persistency model for storing the emission footprints is described with respect to FIG. 6. Examples of software applications consuming the provided emission footprints are described with respect to FIG. 7-9.

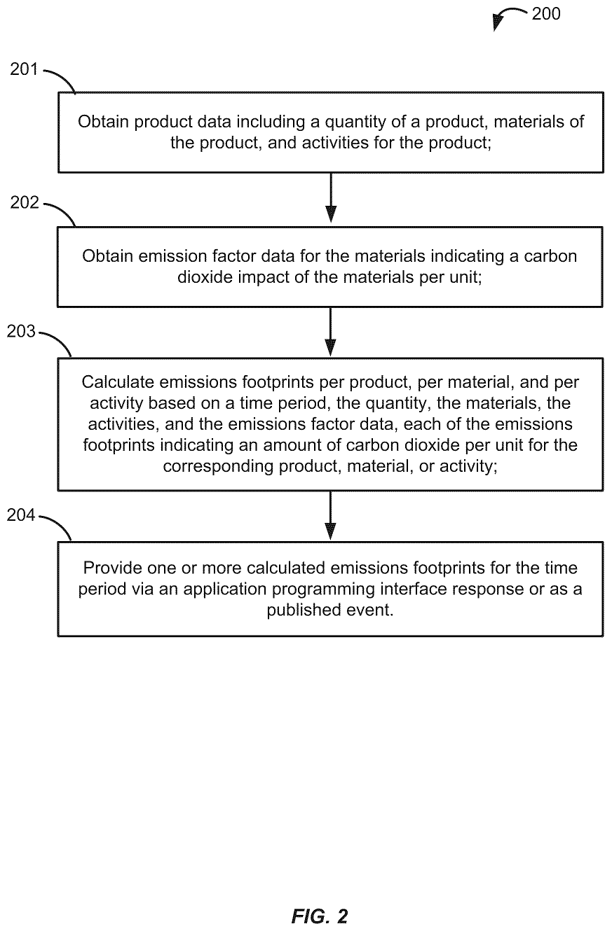

FIG. 2 shows a flowchart 200 of a computer-implemented method for providing emission footprints via an application programming interface (API) and/or published events, according to an embodiment. The method may be performed by a computer system, such as the footprint management system 150 of FIG. 1, a cloud computing platform, or an on-premise computer system, for example. The method may be performed using computer hardware as described below with respect to FIG. 10.

At 201, the method may include obtaining product data including a quantity of a product, components of the product, and activities for the product. The product data may include master data (e.g., product master data, manufacturing plant master data, etc.) and transaction data (e.g., product movement documents, purchase orders, etc.). In some embodiments, the product data may be obtained from a database. For example, an API of the database may be used to pull master data and transaction data. In some embodiments the product data may be obtained from a resource planning system. For example, the resource planning system may push the master data and transaction data via an API.

At 202, the method may include obtaining emission factor data for the components indicating a carbon dioxide impact of the components per unit. The emission factor data may include one or more of an impact category, a footprint indicator, and a respective emission factor value for one or more products, components of products, components, or activities. In some embodiments this emission factor data may be obtained from a supplier or from a life cycle assessment data provider, as mentioned above.

At 203, the method may include calculating emissions footprints per product, per material, and per activity based on a time period, the quantity, the components, the activities, and the emissions factor data. Each of the emissions footprints may indicate an amount of carbon dioxide per unit for the corresponding product, material, or activity. In some embodiments the amount of carbon dioxide per unit may be CO₂ in kilograms or it may be CO₂ equivalent in kilograms (e.g., methane gases converted to their CO₂ equivalent). The time period may be used to restrict the calculation to components used and activities performed to make products during that time period. The emissions footprint calculation may be a bottom up calculation where the corresponding carbon emissions of all components and activities (e.g., manufacturing equipment use, transportation, etc.) used in producing the product are included.

At 204, the method may include providing one or more calculated emissions footprints for the time period via an application programming interface or as a published event. The emissions footprint may be a carbon footprint or greenhouse gas footprint and may quantify the amounts of emissions that were directly or indirectly part of producing the product. The emission footprint may indicate carbon dioxide amounts or carbon dioxide equivalent emitted in producing a certain quantity of product.

In some embodiments, the method may include receiving an application programming interface request including the time period and the calculated emissions footprint may be provided as an application programming interface response. This application programming interface response may further include the product data. In other embodiments the method may involve pushing the calculated emissions footprint via an application programming interface provided by another computer system.

In some embodiments the method may further include publishing an event including a notification of the calculated emissions footprint. The event may identify the product and the time period. In such embodiments the event may not contain the emissions footprint but may serve as notification that the footprint is available to be pulled via the application programming interface. In such embodiments a plurality of footprints may be pulled via the application programming interface at a certain point in time or after a certain interface (e.g., scheduled to run at night, after working hours). In some embodiments the event may be published to an event broker or an event mesh.

In some embodiments the application programming interface request may be received from a product requisition application. In such embodiments, the one or more calculated emissions footprints includes a manufacturing plant based emission footprint or a supplier based emission footprint.

In some embodiments the event itself may include the emissions footprint rather than merely serving as a notification. In such embodiments, the method may include publishing an event including the calculated footprint, an identification of the product, the time period, and the product data.

In some embodiments, the calculation of the emissions footprint is based on a manufacturing process, material acquisition from particular suppliers, and emissions due to transportation.

In some embodiments the emission factor data may be mapped to the product data. In such embodiments, the method may further include mapping the emission factor data for the components to the components of the product. The method may also include mapping activity emission factor data to the activities for the product.

The method may also incorporate the techniques for providing API based and event based emission footprints which are described in detail below.

Different software applications may require specific consumption methods for using/integrating footprints. For example, a resource planning software may use an internal API based approach and an event based approach so that different applications have the choice to choose between loose coupling via events or tight coupling via API along with features like reuse of user interfaces and aggregation over periods can be used per the integration scenarios. Furthermore, certain application may make the footprints available in a standard format so that it can be provided in a consistent and unified format for their consumers. For some applications, having a loosely coupled integration the event-based approach is preferred. For other applications, such as analytics application, it is useful to provide more dimensions along with footprints, like product category, periods, geo-locations, transport modes, fuel/energy types and so on to do analysis of environmental data over such dimensions.

Sequence diagrams for these different ways of providing emission footprints (using an API and/or published events) are described below with respect to FIGS. 3-5. The emission footprints are provided by a footprint manager application or system, which may be configured similar to the footprint management application 160 or the footprint management computer system 150 described above with respect to FIG. 1. The emission footprints are obtained and consumed by one or more product systems, which may be configured similar to the product planning systems 120, database 130, or product requisition application 170 described above with respect to FIG. 1. Herein, the term “consume” refers to the “use” of the emission footprint as integrated into a particular application or use case. The product system may consume the emission footprints after obtaining them from the footprint manager as shown in FIGS. 3-5. Examples of consumption of the emission footprints are shown in FIG. 7-9.

FIG. 3 shows a diagram 300 of API based integration providing emission footprints for consumption, according to an embodiment. The emission footprints are provided by the footprint manager 350 to the product system 380 using an API. In some embodiments, internal API's offered by the source system (e.g., a footprint management system) to push the footprints from footprint manager 350 to the product system 380. In some embodiments, public APIs which are based on standards like PACT defined by World Business Council for Sustainable Development can enable the product system 380 or other integrating systems to push or pull the emission footprint data. In some embodiments, public and analytical APIs may be used which expose the footprint data along with other dimension like product category, geo-locations and so on to slice and dice the footprints data for analysis and decision making.

The sequence flow diagram 300 shows the sequence of processing and communication at and between the footprint manager 350 and the product system 380.

At 301, the footprint manager 350 sends a request to acquire product data to the product system 380.

At 302, the product system 380 sends the product data to the footprint manager 350. The product data may include master data (e.g., information on the product, information on a manufacturing plant producing the product, etc.) and transaction data (e.g., information or documents regarding movement of goods or products, purchase orders, etc.). For example, the product data may include a quantity of a product, components of the product, and activities for the product, as discussed above.

At 303, the footprint manager 350 obtains the product data, which was sent by the product system 380.

At 304, the footprint manager 350 defines a product, a period, and a footprint scope for calculation. Defining a product scope may involve determining or setting an identifier for a particular product or components of a product to be used for the calculation. Defining a period scope may involve setting a particular time period to use for the calculation (e.g., date or time range). Footprint scoping enables the user to check what impact category like CO₂, CO₂e to be calculated and can also influence which transaction data like purchase orders only or physical goods movement documents only or both to be replicated and can be used for calculator. Defining a footprint scope may involve calculating CO₂ equivalent emissions, CO₂ emissions, or both. In some embodiments, other aspects of scoping may involve setting a scope of the calculation in terms of products, product components, manufacturing plants, location of manufacture, etc.

At 305, the footprint manager 350 validates the product, period, and footprint scopes prior to calculation of the footprint. The validation may include checking whether data required for the footprint calculation is stored by or available to the footprint manager 350. For example, checking whether the emission factors that are used in the calculation are already available. If the information is not available for the calculation, it may be obtained and then replicated by the footprint manager 350. In some embodiments the footprint manager 350 may communicate with the product system 380 to determine whether there is any information for the calculation that has not yet been replicated by the footprint manager 350.

At 306, the footprint manager 350 completes the validation of the product, period, and footprint scopes, including any replication of needed data.

At 307, the footprint manager 350 calculates the emission footprints according to the product, period, and footprint scope. The footprint calculation may be a “bottom up” calculation based on materials or components of the product as described herein.

At 308, the footprint manager 350 the calculated footprints are obtained and persisted. The calculated footprints may be a product-plant based footprint and/or a product-plant-supplier based footprint, which are described below with respect to FIG. 6.

At 309, the footprint manager 350 releases the calculated footprints, which are provided to the product system 380 through synchronous communication via one or more APIs. In the context of integration to the product system 380, if the API's are exposed by footprint manager 350 then the product system 380 may ‘pull’ the footprints. In other embodiments one or more APIs are exposed by the product system instead and the footprint manager 350 ‘pushes’ the footprint data to the product system 380.

At 310, the product system 380 persists the footprints. A persistency model for the product-plant based footprint and the product-plant-supplier based footprints are described below with respect to FIG. 6.

At 311, the product system 380 persistence of the footprints is complete. The product system 380 can persist the calculated footprints for further consumption, usage, analysis, etc.

At 312 the product system 380 sends an acknowledgement or response to the footprint manager 350 accordingly.

The table below includes examples of information included in an API request and response are provided below. As shown in the table below, the request may include an identifier of the product (e.g., “product”: “WindTurbine”) as well as a time period (e.g., “calculationPeriod”: {“from”: “01-09-2020”, “to”: “30-09-2020”). The response may include the corresponding calculated emission footprint (e.g., “footprintData”: {“value”: 100.369, “unitofMeasure”: “KG”). In some embodiments the response may also include additional product data that may be used in consumption of the emission footprint (e.g., “ProductData”: {“product”: “WindTurbine”, “baseUnitofMeasure”: “EA”, “plant”: “3085”).

| Request | Response |
|---|---|
| { | { |
| { | { |
| “footprintType”: “product”, | “footprintType”: “product”, |
| “impactCategory”: “GHG/CO2e”, | “impactCategory” : “GHG/CO2e”, |
| “product”: “StrawberryCake”, | “calculationPeriod” : { |
| “calculationPeriod” : { | “from”: “01-01-2022”, |
| “from”: “01-01-2022”, | “to”: “31-01-2022” |
| “to”: “31-01-2022” | }, |
| } | “footprintData” : { |
| } | “value”: 1.458923, |
| | “unitofMeasure”: “KG” |
| | }, |
| | “ProductData” : |
| | { |
| | “product”: “StrawberryCake”, |
| | “baseUnitofMeasure”: “KG”, |
| | “plant”: “5001” |
| | } |
| | } |
| { | { |
| “footprintType”: “product”, | “footprintType”: “product”, |
| “impactCategory”: “GHG/CO2e”, | “impactCategory” : “GHG/CO2e”, |
| “product”: “ WindTurbine”, | “calculationPeriod” : { |
| “calculationPeriod” : { | “from”: “01-09-2020”, |
| “from”: “01-09-2020”, | “to”: “30-09-2020” |
| “to”: “30-09-2020” | }, |
| } | “footprintData” : { |
| } | “value”: 100.369, |
| | “unitofMeasure”: “KG” |
| | }, |
| | “ProductData”: |
| | { |
| | “product”: “ WindTurbine”, |
| | “baseUnitofMeasure”: “EA”, |
| | “plant”: “3085” |
| | } |
| | } |

In some embodiments the API response may include additional product data for consumption in analytical applications. The table below shows examples of such API responses. As shown in the table below, an API response may include footprints for different time periods and may also include additional product data such as the country that the plant producing the product is in (“plantCountry”) and the type of the product (“productType”).

| Request | Response |
|---|---|
| { | { |
| { | “footprintType”:“product”, |
| “footprintType”: “product”, | “elements”:[ |
| “impactCategory”: “GHG/CO2e”, | { |
| “product”: “StrawberryCake”, | “impactCategory”:“GHG/CO2e”, |
| “calculationPeriod” : { | “calculationPeriodFrom”:“01-01- |
| “from”: “01-01-2022”, | 2022”, |
| “to”: “31-01-2022” | “calculationPeriodTo”:“31-01- |
| } | 2022”, |
| } | “footprintValue”:1.458923, |
| | “footprintUnitofMeasure”:“KG”, |
| | “product”:“StrawberryCake”, |
| | “productBaseUnitofMeasure”:“KG”, |
| | “plant”:“5001”, |
| | “plantCountry”:“DE”, |
| | “productType”:“FERT” |
| | }, |
| | { |
| | “impactCategory”:“GHG/CO2e”, |
| | “calculationPeriodFrom”:“01-02- |
| | 2022”, |
| | “calculationPeriodTo”:“28-02- |
| | 2022”, |
| | “footprintValue”:1.3498, |
| | “footprintUnitofMeasure”:“KG”, |
| | “product”:“StrawberryCake”, |
| | “productBaseUnitofMeasure”:“KG”, |
| | “plant”:“5001”, |
| | “plantCountry”:“DE”, |
| | “productType”:“FERT” |
| | }, |
| | ] |
| | } |
| { | { |
| “footprintType”: “product”, | “footprintType”:“product”, |
| “impactCategory”: “GHG/CO2e”, | “elements”:[ |
| “product”: “ WindTurbine”, | { |
| “calculationPeriod” : { | “impactCategory”:“GHG/CO2e”, |
| “from”: “01-09-2020”, | “calculationPeriodFrom”:“01-09- |
| “to”: “30-09-2020” | 2020”, |
| } | “calculationPeriodTo”:“30-09- |
| } | 2020”, |
| | “footprintValue”:100.369, |
| | “footprintUnitofMeasure”:“KG”, |
| | “product”:“WindTurbine”, |
| | “productBaseUnitofMeasure”:“EA”, |
| | “plant”:“3085”, |
| | “plantCountry”:“DE”, |
| | “productType”:“FERT” |
| | } , |
| | { |
| | “impactCategory”:“GHG/CO2e”, |
| | “calculationPeriodFrom”:“01-10- |
| | 2020”, |
| | “calculationPeriodTo”:“31-10- |
| | 2020”, |
| | “footprintValue”:102.45674, |
| | “footprintUnitofMeasure”:“KG”, |
| | “product”:“WindTurbine”, |
| | “productBaseUnitofMeasure”:“EA”, |
| | “plant”:“3085”, |
| | “plantCountry”:“DE”, |
| | “productType”:“FERT” |
| | } |
| | } |

As described above, APIs can be used to provide emission footprints. In some embodiments events are used in the provision of footprints either instead or in addition to the use of APIs. As used herein, an “event” represents a change in the state of data, such as footprints being calculated, data being created or obtained, or certain processes being completed, etc. Often, the sooner an application's users may want to know that an event occurred, so that the application can react, and the user can see the information provided by the event. An event driven architecture may involve messaging between the following participants: a publisher, a messaging system, and a subscriber. The publisher may be the entity that sends or publishes a message (also called a producer). The message contains the information the publisher wants to send. Messages may contain event data (e.g., a notification of a footprint or the footprint data itself), but can also carry queries, commands, and other information.

An event message may describe something that an application needs to tell other applications about. An event stream is a series of event messages published as events occur. The messaging system is the infrastructure that transmits the message (e.g., an event broker and/or event mesh). The subscriber is the ultimate receiver of the message (also called a consumer). In an event-driven architecture, a message typically has a destination that separates the publisher from the subscriber. With an event mesh, a destination may be a topic endpoint or a queue. Topic endpoints and queues are managed by event brokers. An event broker may be middleware that mediates the communication of event messages between producers and consumers using the various message exchange patterns. When an application publishes an event message, the event is sent to an event broker, which then routes the event on to subscribing clients. An example of information contained in an event message is provided below.

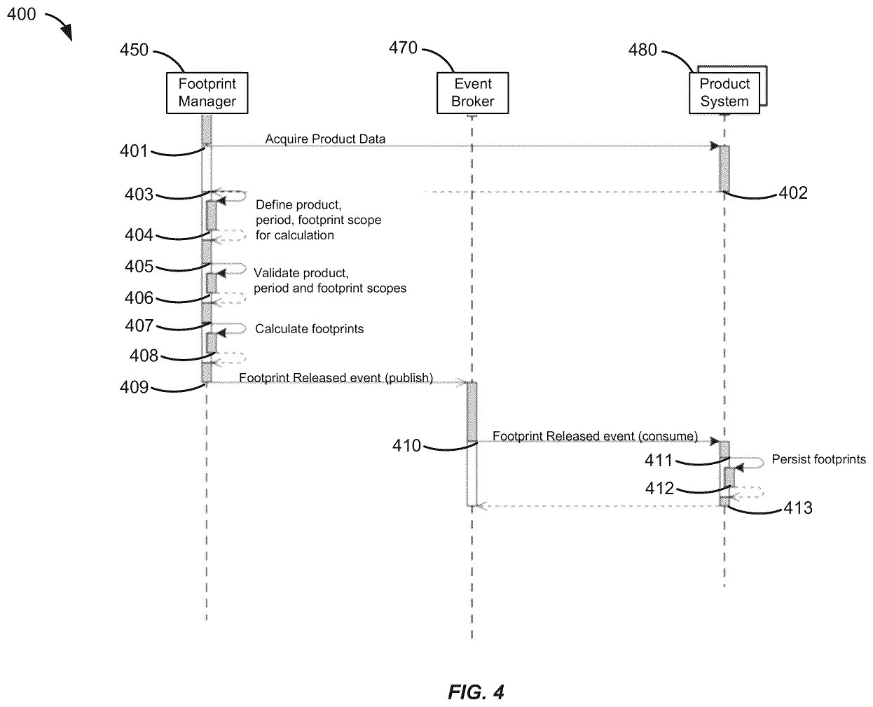

FIG. 4 shows a diagram 400 of data event based integration providing emission footprints for consumption, according to an embodiment. The sequence flow diagram 400 shows the sequence of processing and communication at and between the footprint manager 450, an event broker 470, and a product system 480. In this embodiment, the emission footprints are provided by the footprint manager 450 to the product systems 480 via an event broker 470. In such event based integrations, events may be triggered or raised when footprint calculation is completed or when a footprint is otherwise ready to be published outside of the footprint manager 450 for consumption of footprints environmental data by product system 480. In some embodiments, internal events may be used for integrating internal systems in a loosely coupled manner. In some embodiments, public events may be used for integrating external systems.

At 401, the footprint manager 450 sends a request to acquire product data to the product system 480.

At 402, the product system 480 sends the product data to the footprint manager 450. The product data may include master data (e.g., information on the product, information on a manufacturing plant producing the product, etc.) and transaction data (e.g., information or documents regarding movement of goods or products, purchase orders, etc.). For example, the product data may include a quantity of a product, components of the product, and activities for the product, as discussed above.

At 403, the footprint manager 450 obtains the product data, which was sent by the product system 380.

At 404, the footprint manager 450 defines a product, a period, and a footprint scope for calculation. As mentioned above, footprint scoping enables the user to check what impact category like CO2, CO2e to be calculated and can also influence which transaction data like purchase orders only or physical goods movement documents only or both to be replicated and can be used for calculator. Defining a footprint scope may involve calculating CO2 equivalent emissions, CO2 emissions, or both. In some embodiments, other aspects of scoping may involve setting a scope of the calculation in terms of products, product components, manufacturing plants, location of manufacture, etc. Defining a product scope may involve determining or setting an identifier for a particular product or components of a product to be used for the calculation. Defining a period scope may involve setting a particular time period to use for the calculation (e.g., date or time range).

At 405, the footprint manager 450 validates the product, period, and footprint scopes prior to calculation of the footprint. The validation may include checking whether data required for the footprint calculation is stored by or available to the footprint manager 450. For example, checking whether the emission factors that are used in the calculation are already available. If the information is not available for the calculation, it may be obtained and then replicated by the footprint manager 450. In some embodiments the footprint manager 450 may communicate with the product system 480 to determine whether there is any information for the calculation that has not yet been replicated by the footprint manager 450.

At 406, the footprint manager 450 completes the validation of the product, period, and footprint scopes, including any replication of needed data.

At 407, the footprint manager 450 calculates the emission footprints according to the product, period, and footprint scope. The footprint calculation may be a “bottom up” calculation based on materials or components of the product as described herein.

At 408, the footprint manager 450 the calculated footprints are obtained and persisted. The calculated footprints may be a product-plant based footprint and/or a product-plant-supplier based footprint, which are described below with respect to FIG. 6.

At 409, the footprint manager 450 releases the calculated footprints as one or more published events. In this example the published events are provided to the event broker 470. In some embodiments the event may be a “Footprint Released” event.

At 410 the events processed by event broker 470, which then sends or emits the event to all subscribed or interested systems, including the product system 480, such that those systems may consume the footprint.

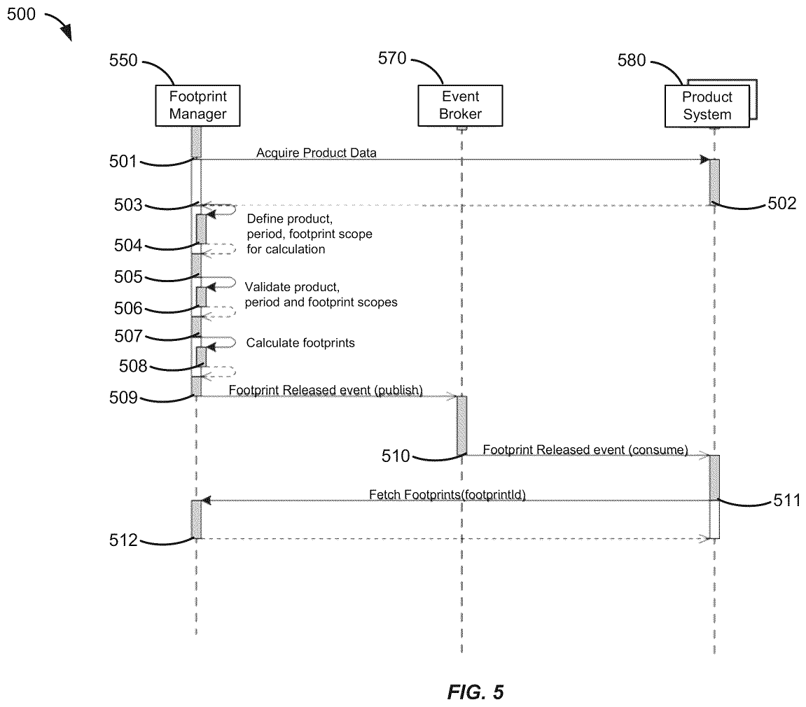

The event raised by the footprint manager 450 may be either a data event or activity event. FIG. 4 shows an example of a data event where the emission footprints are provided in the event while FIG. 5 shows an activity event where the event serves as notification of the footprint being calculated and the footprint itself is obtained later using an API.

At 411, the product system 480 persists the footprints. A persistency model for the product-plant based footprint and the product-plant-supplier based footprints are described below with respect to FIG. 6.

At 412, the product system 480 persistence of the footprints is complete. The product system 480 can persist the calculated footprints for further consumption, usage, analysis, etc.

At 413 the product system 480 sends an acknowledgement or response to the event broker 470 accordingly.

The table below includes examples of information included in a data event message (as opposed to an activity event). As shown in the table below, the event message may include an identifier of the product (e.g., “product”: “WindTurbine”) as well as a time period (e.g., “calculationPeriod”: {“from”: “01-09-2020”, “to”: “30-09-2020”). The event message may include the corresponding calculated emission footprint (e.g., “footprintData”: {“value”: 100.369, “unitofMeasure”: “KG”). In some embodiments the event message may also include additional product data that may be used in consumption of the emission footprint (e.g., “productBaseUnitofMeasure”: “EA”, “plant”: “3085”).

Event

```
{
  “footprintType”:“product”,
  “impactCategory”:“GHG/CO2e”,
  “calculationPeriodFrom”:“01-01-2022”,
  “calculationPeriodTo”:“31-01-2022”,
  “footprintValue”:1.458923,
  “footprintUnitofMeasure”:“KG”,
  “product”:“StrawberryCake”,
  “productBaseUnitofMeasure”:“KG”,
  “plant”:“5001”
}
{
  “footprintType”:“product”,
  “impactCategory”:“GHG/CO2e”,
  “calculationPeriodFrom”:“01-09-2020”,
  “calculationPeriodTo”:“30-09-2020”,
  “footprintValue”:100.369,
  “footprintUnitofMeasure”:“KG”,
  “product”:“WindTurbine”,
  “productBaseUnitofMeasure”:“EA”,
  “plant”:“3085”
}
```

As mentioned above, the event raised by the footprint manager may be either a data event or activity event. An example of an activity event is now described.

FIG. 5 shows a diagram 500 of activity event and API based integration providing emission footprints for consumption, according to an embodiment. The sequence flow diagram 500 shows the sequence of processing and communication at and between the footprint manager 550, an event broker 570, and a product system 580. In this embodiment, the emission footprints are provided by the footprint manager 550 to the product systems 580 via an event broker 570. In such event based integrations, events may be triggered or raised when footprint calculation is completed or when a footprint is otherwise ready to be published outside of the footprint manager 550 for consumption of footprints environmental data by product system 580. In some embodiments, internal events may be used for integrating internal systems in a loosely coupled manner. In some embodiments, public events may be used for integrating external systems.

At 501, the footprint manager 550 sends a request to acquire product data to the product system 580.

At 502, the product system 580 sends the product data to the footprint manager 550. The product data may include master data (e.g., information on the product, information on a manufacturing plant producing the product, etc.) and transaction data (e.g., information or documents regarding movement of goods or products, purchase orders, etc.). For example, the product data may include a quantity of a product, components of the product, and activities for the product, as discussed above.

At 503, the footprint manager 550 obtains the product data, which was sent by the product system 380.

At 504, the footprint manager 550 defines a product, a period, and a footprint scope for calculation. As mentioned above, footprint scoping enables the user to check what impact category like CO2, CO2e to be calculated and can also influence which transaction data like purchase orders only or physical goods movement documents only or both to be replicated and can be used for calculator. Defining a footprint scope may involve calculating CO2 equivalent emissions, CO2 emissions, or both. In some embodiments, other aspects of scoping may involve setting a scope of the calculation in terms of products, product components, manufacturing plants, location of manufacture, etc. Defining a product scope may involve determining or setting an identifier for a particular product or components of a product to be used for the calculation. Defining a period scope may involve setting a particular time period to use for the calculation (e.g., date or time range).

At 505, the footprint manager 550 validates the product, period, and footprint scopes prior to calculation of the footprint. The validation may include checking whether data required for the footprint calculation is stored by or available to the footprint manager 550. For example, checking whether the emission factors that are used in the calculation are already available. If the information is not available for the calculation, it may be obtained and then replicated by the footprint manager 550. In some embodiments the footprint manager 550 may communicate with the product system 580 to determine whether there is any information for the calculation that has not yet been replicated by the footprint manager 550.

At 506, the footprint manager 550 completes the validation of the product, period, and footprint scopes, including any replication of needed data.

At 507, the footprint manager 550 calculates the emission footprints according to the product, period, and footprint scope. The footprint calculation may be a “bottom up” calculation based on materials or components of the product as described herein.

At 508, the footprint manager 550 the calculated footprints are obtained and persisted. The calculated footprints may be a product-plant based footprint and/or a product-plant-supplier based footprint, which are described below with respect to FIG. 6.

At 509, the footprint manager 550 releases the calculated footprints as one or more published events. In this example the published events are provided to the event broker 570. In some embodiments the event may be a “Footprint Released” event. In this example the event may be an activity event that serves as a notification that the footprints have been calculated but may not include the footprints themselves. This event may include an identifier of the footprint that has been calculated (e.g., a “footprintId”). Instead, the footprints may be obtained using an API as described below.

At 510 the events processed by event broker 570, which then sends or emits the event to all subscribed or interested systems, including the product system 580, such that those systems may consume the footprint notification. For example, the product system 580 may schedule a job to pull the footprints at a certain time.

At 511, the product system 580 sends an API request message to the footprint manager 550 to obtain or “fetch” a footprint (Fetch Footprints (footprintId)). The request message may include an identifier of the footprint, which may have been included in the event.

At 512, the footprint manager 550 sends an API response message including the calculated footprint to the product system 580.

The table below includes examples of information included in a data event message (as opposed to an activity event). As shown in the table below, the event message may include an identifier of the product (e.g., “product”: “WindTurbine”) as well as a time period (e.g., “calculationPeriod”: {“from”: “01-09-2020”, “to”: “30-09-2020”). However, with the activity event, the event message may not include the corresponding calculated emission footprint (e.g., “footprintData”: {“value”: 100.369, “unitofMeasure”: “KG”), as described above with respect to the data events of FIG. 4. With activity events, the event may also not include product data (e.g., “productBaseUnitofMeasure”: “EA”, “plant”: “3085”, etc.), which was described above with respect to FIG. 4.

Event

```
{
  “footprintType”:“product”,
  “impactCategory”:“GHG/CO2e”,
  “calculationPeriodFrom”:“01-01-2022”,
  “calculationPeriodTo”:“31-01-2022”,
}
{
  “footprintType”:“product”,
  “impactCategory”:“GHG/CO2e”,
  “calculationPeriodFrom”:“01-09-2020”,
  “calculationPeriodTo”:“30-09-2020”,
}
```

The information included in the API request and response in the diagram 500 of FIG. 5 may be similar to those described above with respect to FIG. 3, except that in FIG. 3 the footprint manager 350 “pushed” the footprints to the product system 380 with the “Release Footprints” communication while in FIG. 5 the product system 580 “pulls” the footprints from the footprint manager 550 with “FetchFootprints (footprintId)” communication.

As mentioned above, persistence of the calculated footprints may be product-plant based and/or product-plant-supplier based. FIG. 6 shows a diagram 600 of a persistency data model for emission footprints, according to an embodiment.

A ProductPlantFootprints 610 model for persisting footprints based on information on a product 601 from a manufacturing plant 602 is shown in the diagram 600. This model includes information on a time period including a start period (startPeriod) and an end period (endPeriod). It also includes information on the product (product), the manufacturing plant (plant), and the base unit of measure for the footprint (baseUnitofMeasure), which may be in grams, kilograms, or per product, etc. The model also includes a footprint impact category (footprintImpactCategory), such as greenhouse gas (GHG)/CO₂ equivalent, for example. The model also includes a footprint value (footprint Value), which may be a numerical value. It also includes a footprintValueUnitofMeasure (e.g., kilograms CO₂ or CO₂ equivalent). It also includes a footprint value calculation reference identifier (footprint ValueCalculationReferenceId), which may be used to request or fetch the footprints (e.g., Fetch Footprints (footprintId) as 511 in FIG. 5).

A persistence model for ProductPlantSupplierFootprints 620 is based on information on a product 601 from a manufacturing plant 602 and a Supplier 603 is shown in the diagram 600. This model may be similar to the ProductPlantFootprints model except that it also includes information on the supplier. This model includes information on a time period including a start period (startPeriod) and an end period (endPeriod). It also includes information on the product (product), the manufacturing plant (plant), and the base unit of measure for the footprint (baseUnitofMeasure), which may be in grams, kilograms, or per product, etc. The model also includes information on the supplier (supplier), which may include a name or identifier of the supplier. The model also includes a footprint impact category (footprintImpactCategory), such as greenhouse gas (GHG)/CO₂ equivalent, for example. The model also includes a footprint value (footprintValue), which may be a numerical value. It also includes a footprintValueUnitofMeasure (e.g., kilograms CO₂ or CO₂ equivalent). It also includes a footprint value calculation reference identifier (footprintValueCalculationReferenceId), which may be used to request or fetch the footprints (e.g., Fetch Footprints (footprintId) as 511 in FIG. 5).

Examples of how emission footprints can be consumed are described below with respect to FIG. 7-9.

FIG. 7 shows an illustration 700 of consumption of an emission footprint and shows emissions per product component, according to an embodiment. Illustration 700 shows information that can be presented in a user interface for an online shopping application for a consumer. The footprints for a product such as a laptop can display the environmental impact to produce it along with the price details. In the online shopping application, the footprints for the laptop can be consumed and used to display the environmental impact to produce it and the contribution from its components.

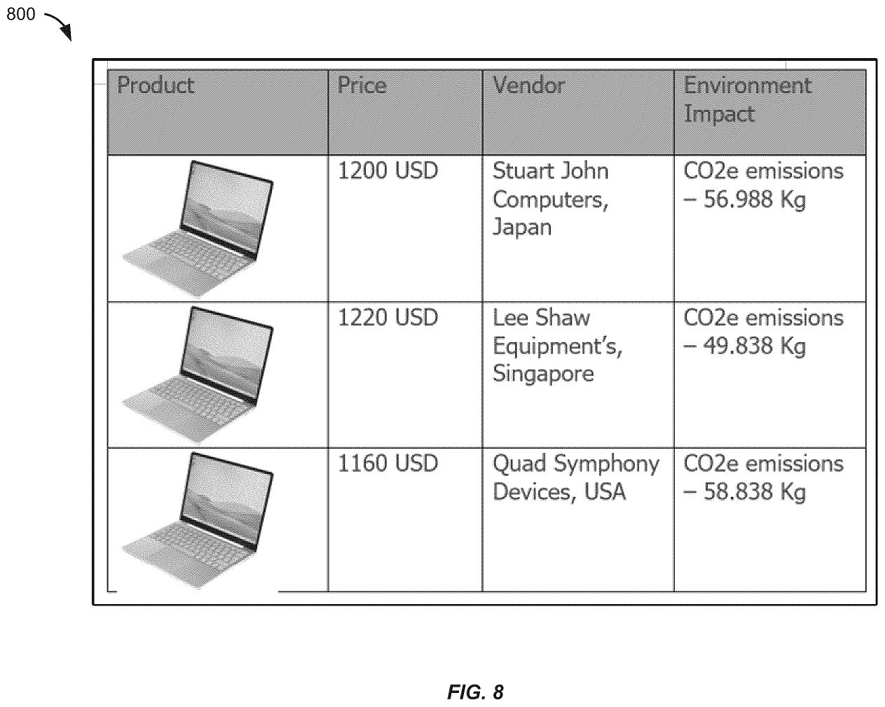

FIG. 8 shows an illustration 800 of consumption of an emission footprint and shows emissions per product and vendor, according to an embodiment. Illustration 800 shows information that can be presented in a user interface for an online shopping application for a consumer. The footprints for a product such as a laptop can display the environmental impact to produce the laptop, which are sold by different vendor along with the price details.

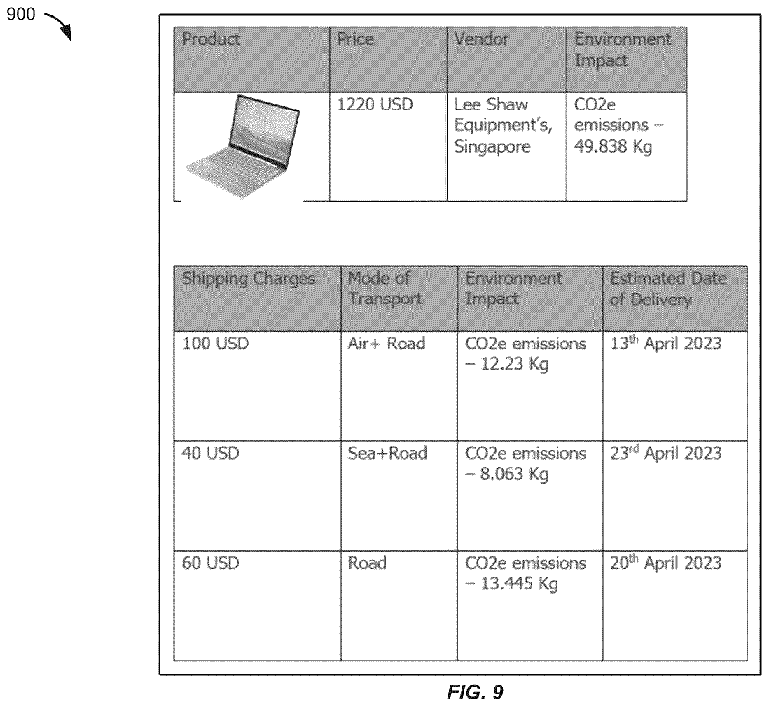

FIG. 9 shows an illustration 900 of consumption of an emission footprint and shows emissions per shipping options from a vendor, according to an embodiment. Illustration 900 shows information that can be presented in a user interface for an online shopping application for a consumer. The footprints for a product such as a laptop can display the environmental impact to produce the laptop which are sold by a vendor using different transport mode along with the price details. In this example, the consumer is based out of Bangalore, India and the Vendor is Lee Shaw Equipment's, Singapore. The consumer can be shown with the options for shipping the product which includes shipping charges, transport mode, environmental impact and the estimated delivery date (ETD).

Other examples of consumption of emissions footprints are described below.

As one example, an on-premise or cloud-based database application can provide view in of product footprints. In some embodiments the footprints may be stored in the database and delivered using API based integration between the footprint manager and the database manager. In other embodiments loosely event based integration may be used.

Another example of consumption is a purchase requisition application that replicates API based footprints and integrations information from the footprints into a purchase requisition application to see CO2e and environmental impact along with financial values. In some embodiments, event based integration may be loosely coupled and may also enable the above scenario in procurement.

CO2e footprints can also be integrated into Sales Order documents which are used as document when Customers are buying the products. For example, “JJ Wind Turbines” as a manufacturing company for product “Wind Turbines” sell these turbines to Customers like “Karnataka State Electricity Board” the related CO2e footprints along with related price can be seen in the Sales Order document.

As another example, a shopping cart/online shopping apps which allows the end user to purchase a variety of goods can also see the CO2e emissions that went in from procurement of raw material to the manufacture of end product along with transport/freight emissions can be shown to the end user to help them in sustainable buying.

As another example, a data analytics application may provide a dashboard with visualizations of information built on the footprints API. For example, a heatmap chart for a Product Group/Category “Oils & Fats” may be presented and show insights about footprints accumulated due to procurement of purchased products from different vendors which are spread across the globe and can help the businesses to act for reduction of CO2e emissions.

### Example Embodiments

Example embodiments are described below.

Some embodiments provide a computer system, comprising one or more processors and one or more machine-readable medium coupled to the one or more processors and storing computer program code comprising sets of instructions executable by the one or more processors. The sets of instructions are executable to obtain product data including a quantity of a product, components of the product, and activities for the product. The sets of instructions are executable to obtain emission factor data for the components indicating a carbon dioxide impact of the components per unit. The sets of instructions are executable to calculate one or more emissions footprints per product, per material, and per activity based on a time period, the quantity, the components, the activities, and the emission factor data, each of the emissions footprints indicating an amount of carbon dioxide per unit for a corresponding product, material, or activity. The sets of instructions are executable to provide the one or more calculated emissions footprints for the time period via an application programming interface or as a published event.

In some embodiments the sets of instructions are executable to receive an application programming interface request including the time period, wherein the one or more calculated emissions footprints are provided as an application programming interface response, wherein the application programming interface response further includes the product data.

In some embodiments the sets of instructions are executable to publish an event including a notification of the one or more calculated emissions footprints, the event identifying the product and the time period.

In some embodiments the application programming interface request is received from a product requisition application, and wherein the one or more calculated emissions footprints include a manufacturing plant based emission footprint or a supplier based emission footprint.

In some embodiments the sets of instructions are executable to publish an event including the one or more calculated emissions footprints, an identification of the product, the time period, and the product data.

In some embodiments the calculation of the one or more emissions footprints is based on a manufacturing process, material acquisition from particular suppliers, and emissions due to transportation.

In some embodiments the sets of instructions are executable to map the emission factor data for the components to the components of the product and map activity emission factor data to the activities for the product.

Some embodiments provide a non-transitory computer-readable medium storing computer program code comprising sets of instructions. The computer program code comprises sets of instructions to obtain product data including a quantity of a product, components of the product, and activities for the product. The computer program code comprises sets of instructions to obtain emission factor data for the components indicating a carbon dioxide impact of the components per unit. The computer program code comprises sets of instructions to calculate one or more emissions footprints per product, per material, and per activity based on a time period, the quantity, the components, the activities, and the emission factor data, each of the emissions footprints indicating an amount of carbon dioxide per unit for a corresponding product, material, or activity. The computer program code comprises sets of instructions to provide the one or more calculated emissions footprints for the time period via an application programming interface or as a published event.

In some embodiments, the computer program code comprises sets of instructions to receive an application programming interface request including the time period, wherein the one or more calculated emissions footprints are provided as an application programming interface response, wherein the application programming interface response further includes the product data.

In some embodiments, the computer program code comprises sets of instructions to publish an event including a notification of the one or more calculated emissions footprints, the event identifying the product and the time period.

In some embodiments, the application programming interface request is received from a product requisition application, and wherein the one or more calculated emissions footprints include a manufacturing plant based emission footprint or a supplier based emission footprint.

In some embodiments, the computer program code comprises sets of instructions to publish an event including the one or more calculated emissions footprints, an identification of the product, the time period, and the product data.

In some embodiments, the calculation of the one or more emissions footprints is based on a manufacturing process, material acquisition from particular suppliers, and emissions due to transportation.

In some embodiments, the computer program code comprises sets of instructions to map the emission factor data for the components to the components of the product and map activity emission factor data to the activities for the product.

Some embodiments provide a computer-implemented method. The method comprises obtaining product data including a quantity of a product, components of the product, and activities for the product. The method comprises obtaining emission factor data for the components indicating a carbon dioxide impact of the components per unit. The method comprises calculating one or more emissions footprints per product, per material, and per activity based on a time period, the quantity, the components, the activities, and the emission factor data, each of the emissions footprints indicating an amount of carbon dioxide per unit for a corresponding product, material, or activity. The method comprises providing the one or more calculated emissions footprints for the time period via an application programming interface or as a published event.

In some embodiments, the method comprises receiving an application programming interface request including the time period, wherein the one or more calculated emissions footprints are provided as an application programming interface response, wherein the application programming interface response further includes the product data.

In some embodiments, the method comprises publishing an event including a notification of the one or more calculated emissions footprints, the event identifying the product and the time period.

In some embodiments, the application programming interface request is received from a product requisition application, and wherein the one or more calculated emissions footprints include a manufacturing plant based emission footprint or a supplier based emission footprint.

In some embodiments, the method comprises publishing an event including the one or more calculated emissions footprints, an identification of the product, the time period, and the product data.

In some embodiments, the method comprises mapping the emission factor data for the components to the components of the product and mapping activity emission factor data to the activities for the product.

### Example Hardware

FIG. 10 shows a diagram 1000 of hardware of a special purpose computing machine for implementing systems and methods described herein. The following hardware description is merely one example. It is to be understood that a variety of computers topologies may be used to implement the above described techniques. The hardware shown in FIG. 10 may be used to implement the computer systems and computer software (computer reprogram code) described herein.

The computer system 1010 includes a bus 1005 or other communication mechanism for communicating information, and one or more processor(s) 1001 coupled with bus 1005 for processing information. The computer system 1010 also includes a memory 1002 coupled to bus 1005 for storing information and instructions to be executed by processor 1001, including information and instructions for performing some of the techniques described above, for example. This memory may also be used for storing programs executed by processor(s) 1001. Possible implementations of this memory may be, but are not limited to, random access memory (RAM), read only memory (ROM), or both. A storage device 1003 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 1003 may include source code, binary code, or software files for performing the techniques above, for example. Storage device and memory are both examples of non-transitory computer-readable storage mediums.

The computer system 1010 may be coupled via bus 1005 to a display 1012 for displaying information to a computer user. An input device 1011 such as a keyboard, touchscreen, and/or mouse is coupled to bus 1005 for communicating information and command selections from the user to processor 1001. The combination of these components allows the user to communicate with the system. In some systems, bus 1005 represents multiple specialized buses, for example.

The computer system also includes a network interface 1004 coupled with bus 1005. The network interface 1004 may provide two-way data communication between computer system 1010 and a network 1020. The network interface 1004 may be a wireless or wired connection, for example. The network 1020 may be a local area network or an intranet, for example. The computer system 1010 can send and receive information through the network interface 1004, across the network 1020, to computer systems connected to the Internet 1030. Using the Internet 1030 the computer system 1010 may access data and features that reside on multiple different hardware servers 1031, 1032, 1033, 1034. The servers 1031-1034 may be part of a cloud computing environment in some embodiments.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations, and equivalents may be employed without departing from the scope of the present disclosure as defined by the claims.

What is claimed is:

1. A computer system, comprising:
one or more processors;
one or more machine-readable medium coupled to the one or more processors and storing computer program code comprising sets of instructions executable by the one or more processors to:
obtain product data including a quantity of a product, components of the product, and activities for the product;
obtain emission factor data for the components indicating a carbon dioxide impact of the components per unit;
calculate one or more emissions footprints per product, per material, and per activity based on a time period, the quantity, the components, the activities, and the emission factor data, each of the emissions footprints indicating an amount of carbon dioxide per unit for a corresponding product, material, or activity; and
provide the one or more calculated emissions footprints for the time period via an application programming interface or as a published event.

2. The computer system of claim 1, wherein the computer program code further comprises sets of instructions executable by the one or more processors to:
receive an application programming interface request including the time period, wherein the one or more calculated emissions footprints are provided as an application programming interface response, wherein the application programming interface response further includes the product data.

3. The computer system of claim 2, wherein the computer program code further comprises sets of instructions executable by the one or more processors to:
publish an event including a notification of the one or more calculated emissions footprints, the event identifying the product and the time period.

4. The computer system of claim 3, wherein the application programming interface request is received from a product requisition application, and wherein the one or more calculated emissions footprints include a manufacturing plant based emission footprint or a supplier based emission footprint.

5. The computer system of claim 1, wherein the computer program code further comprises sets of instructions executable by the one or more processors to:
publish an event including the one or more calculated emissions footprints, an identification of the product, the time period, and the product data.

6. The computer system of claim 1, wherein the calculation of the one or more emissions footprints is based on a manufacturing process, material acquisition from particular suppliers, and emissions due to transportation.

7. The computer system of claim 1, wherein the computer program code further comprises sets of instructions executable by the one or more processors to:
map the emission factor data for the components to the components of the product; and
map activity emission factor data to the activities for the product.

8. A non-transitory computer-readable medium storing computer program code comprising sets of instructions to:
obtain product data including a quantity of a product, components of the product, and activities for the product;
obtain emission factor data for the components indicating a carbon dioxide impact of the components per unit;
calculate one or more emissions footprints per product, per material, and per activity based on a time period, the quantity, the components, the activities, and the emission factor data, each of the emissions footprints indicating an amount of carbon dioxide per unit for a corresponding product, material, or activity; and
provide the one or more calculated emissions footprints for the time period via an application programming interface or as a published event.

9. The non-transitory computer-readable medium of claim 8, wherein the computer program code further comprises sets of instructions to:
receive an application programming interface request including the time period, wherein the one or more calculated emissions footprints are provided as an application programming interface response, wherein the application programming interface response further includes the product data.

10. The non-transitory computer-readable medium of claim 9, wherein the computer program code further comprises sets of instructions to:
publish an event including a notification of the one or more calculated emissions footprints, the event identifying the product and the time period.

11. The non-transitory computer-readable medium of claim 10, wherein the application programming interface request is received from a product requisition application, and wherein the one or more calculated emissions footprints include a manufacturing plant based emission footprint or a supplier based emission footprint.

12. The non-transitory computer-readable medium of claim 8, wherein the computer program code further comprises sets of instructions to:
publish an event including the one or more calculated emissions footprints, an identification of the product, the time period, and the product data.

13. The non-transitory computer-readable medium of claim 8, wherein the calculation of the one or more emissions footprints is based on a manufacturing process, material acquisition from particular suppliers, and emissions due to transportation.

14. The non-transitory computer-readable medium of claim 8, wherein the computer program code further comprises sets of instructions to:
map the emission factor data for the components to the components of the product; and
map activity emission factor data to the activities for the product.

15. A computer-implemented method, comprising:
obtaining product data including a quantity of a product, components of the product, and activities for the product;
obtaining emission factor data for the components indicating a carbon dioxide impact of the components per unit;
calculating one or more emissions footprints per product, per material, and per activity based on a time period, the quantity, the components, the activities, and the emission factor data, each of the emissions footprints indicating an amount of carbon dioxide per unit for a corresponding product, material, or activity; and
providing the one or more calculated emissions footprints for the time period via an application programming interface or as a published event.

16. The computer-implemented method of claim 15, further comprising:
receiving an application programming interface request including the time period, wherein the one or more calculated emissions footprints are provided as an application programming interface response, wherein the application programming interface response further includes the product data.

17. The computer-implemented method of claim 16, further comprising:
publishing an event including a notification of the one or more calculated emissions footprints, the event identifying the product and the time period.

18. The computer-implemented method of claim 17, wherein the application programming interface request is received from a product requisition application, and wherein the one or more calculated emissions footprints include a manufacturing plant based emission footprint or a supplier based emission footprint.

19. The computer-implemented method of claim 15, further comprising:
publishing an event including the one or more calculated emissions footprints, an identification of the product, the time period, and the product data.

20. The computer-implemented method of claim 15, further comprising:
mapping the emission factor data for the components to the components of the product; and
mapping activity emission factor data to the activities for the product.
